(19) United States
(12) Patent Application Publication
(10) Pub. No.: US 2011/0290866 A1
(43) Pub. Date: Dec. 1, 2011

(54) Folder With Gusset

(75) Inventors: Darryll Dodson, Minneapolis, MN (US); Duane Christensen, Hastings, MN (US)

(73) Assignee: Smead Manufacturing Company, Hastings, MN (US)

(21) Appl. No.: 13/207,069

(22) Filed: Aug. 10, 2011

Related U.S. Application Data
(63) Continuation of application No. 12/894,771, filed on Sep. 30, 2010.
Application No. 12/894,771 is a continuation of application No. 12/193,082, filed on Aug. 18, 2008, now abandoned.
(60) Provisional application No. 60/956,439, filed on Aug. 17, 2007.
(60) Provisional application No. 61/024,745, filed on Jan. 30, 2008.

(51) Int. Cl. B65D 27/00; B31B 47/02

(52) U.S. Cl. 229/67.2; 493/267

(57) ABSTRACT

A hanging pocket folder for use with support rails is disclosed. The disclosure includes a method and structure for preventing the side walls thereof from being damaged when the folder is withdrawn from a rail support system. Prior art systems did not recognize the problem of snagging sidewalls with withdrawal. The present disclosure provides for side walls which preferably exceed the height of the lower edge of the support rails and thus never snag on withdrawal despite the fact that the accordion sidewall may easily be deformed from use. A further embodiment discloses an elastic sidewall and integral tabs.

### CROSS REFERENCE TO RELATED APPLICATION

This application claims the benefit of U.S. Provisional Application No. 60/956439 filed 17 Aug. 2007, and claims the benefit of U.S. Provisional Application No. 61/024745 filed 30 Jan. 2008, which hereby are incorporated herein by reference in its entirety.

### BACKGROUND OF THE INVENTION

1. Field of the Invention

This invention relates to the field of office supplies/requisites, more particularly, folders, folios, folders etc, which hold documents or items.

2 . Background

A most common type of document holder is a folder having accordion style gussets which expand and contract to accept varying amounts of documents or other items. Such folders have been around for decades.

Such prior art folders universally have a pair of opposing sidewalls connected at the top, bottom and sides by a gusset material which is typically made of paper or other inexpensive material. More importantly, the gusset material extends across the bottom and up the side of the folder to about one half to two thirds the height—of the folder sideways.

This one-half/two-third height is designed to make access to the documents in the folder easier, however it also has a serious drawback, namely, that the gusset sidewall snags the file drawer (or other holder) when being removed. This is because they begin to pucker out after only a small amount of use and do not fully retract.

When such sidewalls snag, they are typically ripped during removal which either destroys the gusset or shortens its life.

This problem has been around since the first gusset holder/folder was made, yet there has been no effective solution to this problem which does not substantially increase the cost of the folder. Reinforcement of the gusset material is expensive or makes the gusset less resilient, only compounding the problem.

The present disclosure provides a most elegant solution by virtue of its simplicity and low cost and despite the long felt need for this solution, it has not heretofore been adopted even though the technology to do so has long been available.

### BRIEF SUMMARY

The present disclosure includes a folder/holder with opposing substantially planar sidewalls which are connected to each other by an accordion like gusset which spans the bottom edge of the opposing sidewalls, and likewise extends to substantially the entire length of the side edge of the sidewall from bottom to nearly the top, so that when the folder is withdrawn from a file drawer it is less likely to snag those sidewalls on the file drawer.

The side gusset may extend the entire length or substantially the entire length. It may exclude the region toward the top where support bars may be located in the case of a hanging style folder.

There is also disclosed a hanging pocket for use in a support frame having spaced apart support rails, said rails having upper and lower edges, having a pocket with two generally spaced apart faces, having upper and lower edges, right and left edges; a support bar affixed to said faces at said upper edges, said bar including hooks configured to ride on said rails; a bottom panel joining said faces at said lower edges; and a pair of corrugated side panels extending from said lower edges, joining said left and right edges of adjacent faces and terminating at least above the lower edges of said rails, when said pocket is supported by said hooks on said rails.

Also disclosed is a hanging pocket for use in a support frame having spaced apart support rails, said rails having upper and lower edges having a pocket with two generally spaced apart faces, having upper and lower edges, right and left edges; a support bar affixed to said faces at said upper edges, said bar including hooks configured to ride on said rails; a bottom panel joining said faces at said lower edges; and a pair of an elastic side panel material extending from said lower edges, joining said left and right edges of adjacent faces and terminating at least above the lower edges of said rails, when said pocket is supported by said hooks on said rails.

Also disclosed is the method of preventing snagging of side walls of a hanging pocket for use in a support frame having spaced apart support rails, said rails having upper and lower edges, a pocket having two generally spaced apart faces, having upper and lower edges, right and left edges; a support bar affixed to said faces at said upper edges, said bar including hooks configured to ride on said rails; bottom panel joining said faces at said lower edges; and a pair of corrugated side panels extending from said lower edges, joining said left and right edges of adjacent faces; the method extending the side panels so they terminate at least above the lower edges of said rails, when said pocket is supported by said hooks on said rails.

### BRIEF DESCRIPTION OF THE SEVERAL VIEWS OF THE DRAWINGS

FIG. 1 shows a device according to the present invention and a prior art device carried in the same rail support system.

FIG. 2 is a perspective of an embodiment according to the present invention.

FIG. 3 is a perspective drawing of a hanging file folder with an integral tab.

FIG. 4 is a plan drawing of a portion of paper stock in an unassembled state, which shows the cutting and folding scheme for producing the integral tab shown in FIG. 3.

### DETAILED DESCRIPTION OF THE INVENTION

The present invention involves file folders. The term file folders should be interpreted broadly to include pockets or other holding media typically used to store items or documents and which are often themselves stored in file cabinets, shelving or other further storage systems.

The invention relates to a system and method for making a folder with an expandable side gusset which must expand or contract to accommodate varying loads and capacities.

FIG. 2 shows an embodiment with a gusset 100 and two opposing substantially planar sidewalls 120, 140 each having a top edge 160, side edges 170, and bottom edge 180.

The gusset material 210 is typically a paper or composite possibly reinforced with a material like Tyvek®. It may even have a special reinforcing edge cover/protector 200 but this is not necessary as it is a legacy from the prior art.

In the embodiment shown, there are support bars 215, of a type well known in the art.

The gusset has a bottom wall 220, not visible but identical in its corrugated structure, joining the sidewalls and sidewall gussets 240 which extend preferably continuously from the bottom wall 220 to substantially the uppermost edge 160 of the sidewalls.

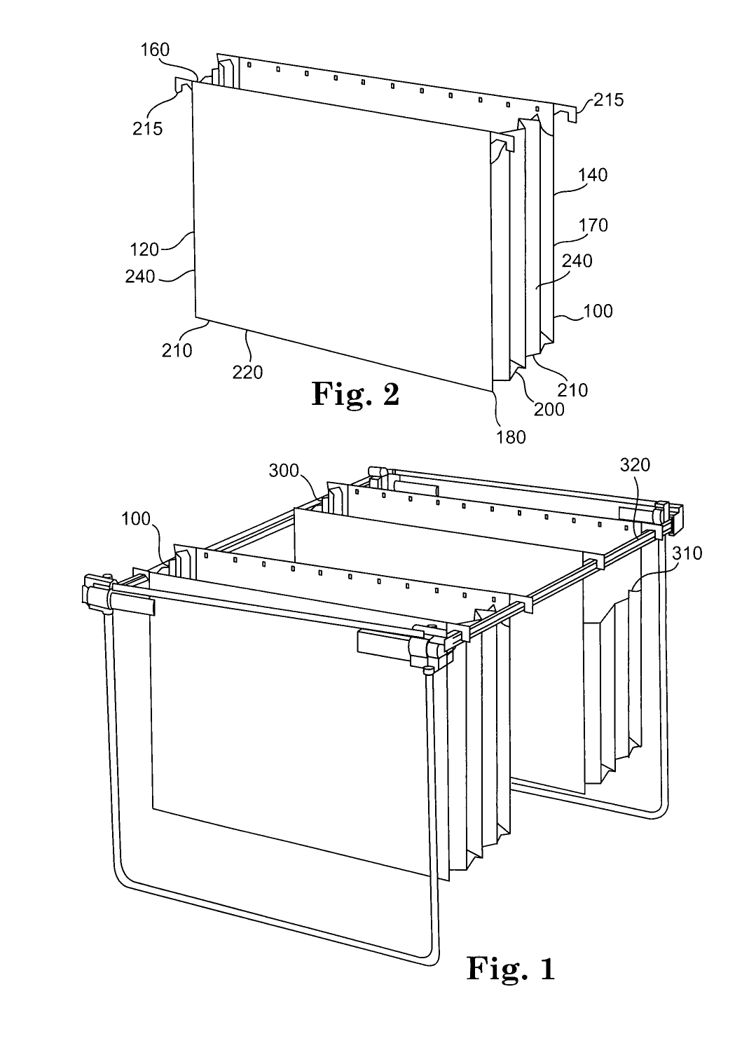

The term “to substantially the uppermost edge” requires definition. It does not necessarily mean that the gusset material actually reaches the very top edge, defined by the top of the support rod 160, but is close thereto. As shown in FIG. 1 and FIG. 2, the gusset terminates preferably just below the bar, but at least high enough to reach the bottom edge of rail 320 so that it will never snag. In the case of other configurations, the gusset may terminate short of the top edge by a small distance, typically 1-20 mm, preferably about 10 mm that is, between the upper and lower edges of rails 320, or equal to or above the upper edge of the rails. This is high enough to prevent snagging (ie enough to always stay above the lower edge of rail 320), but low enough to simplify the manufacturing of the top edge. If the top edge is rounded, it is difficult to create a smooth and continuous intersection of materials due to the complex shapes required. Therefore, the concept of being “substantially” at the top edge is met by this definition.

The side gusset may extend the entire length or substantially the entire length. It may exclude the region toward the top where support bars may be located in the case of a hanging style folder.

It is possible to replace the accordion material with an entirely different material, such as a resilient member, such as Spandex® or other stretchy/elastic non-corrugated film or weave. This material is preferably adapted to maintain a bias force against the papers held in the pocket folder yet capable of expansion as need and still retain the bias force. This eliminates the need for the accordion structure. This is particularly attractive because it insures compression of the documents without the fatigue associated with paper. It too would be subjected to snagging as in the prior art, but not as severely as it would be under constant tension, so it could be less than full height, and even traditional heights (one half, two thirds, etc.).

It is possible to combine the benefits of Spandex® like materials with papers by alternating sections of the accordion wall with paper and Spandex® resilient sections. It is also possible to have the stretch material in either full height (ie just above the bottom edge of rail 320 or below the edge), both as shown in FIG. 1.

It is also possible to integrate a tab into the upper edge of the folder so that it does not require the installation of a separate tab.

FIG. 1 illustrates how the “full height” gusset shown as 100 compares to that sub-height gusset folder 300. Note the splaying of the gusset materials at 310 which will easily snag on the top rail 320. The full height version 100 is at least just equal to or higher than the lower edge of support rail structure 320, as shown in FIG. 1, and thus will not be trapped when removed and is prevented from splaying.

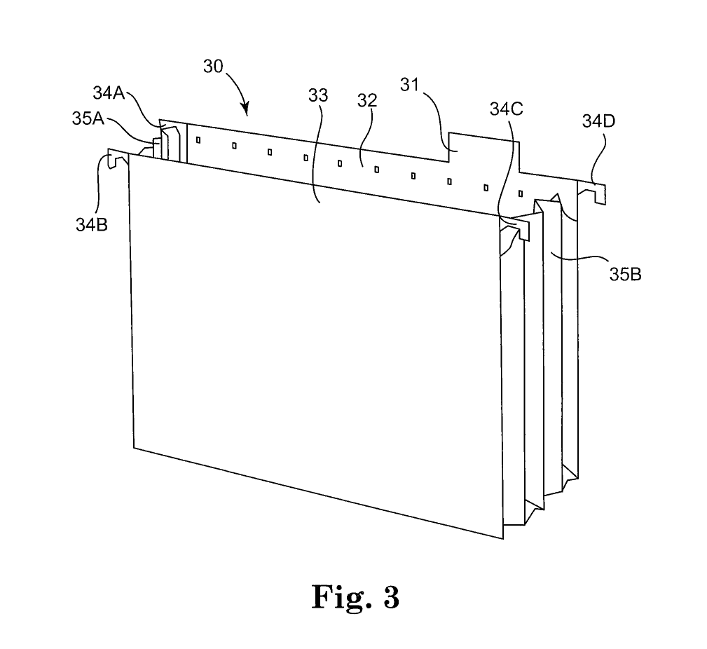

FIG. 3 is a plan drawing of a hanging file folder 30 with an integrated tab 31. It will be appreciated that this integral tab can be placed anywhere along the top edge (such as configurations know as 3 cut/5 cut, etc) or as end tabs. There may also be multiple tabs along the top and they may be detachable, such as by perforations or cutting so that the user can decide how many tabs are desired.

The tab 31 may also extend across all or a portion of the top edge of the front face 32, the top edge of the rear face 33, or the top edges of both front and rear faces of the folder. The tab 31 may optionally extend across two one-inch hole spacings along the top edge, thereby subtending the same length along the top edge as a typical removable tab. Alternatively, the tab 31 may subtend about one-third of the total top edge length, and may be disposed as a “left third”, “middle third”, and/or a “right third” tab. The tab 31 may be the same color as the front face 32 and/or rear face 33, or may alternatively be a different color from both front and rear faces. The tab 31 may be a lighter color than front and rear faces, so that anything written on the tab will have more contrast than if it were written on the front or rear faces. The tab 31 may include an optional horizontal line, so that two lines of text may be written on the tab. The tab 31 may be accompanied by optional labels, so that any identifying indicia may be written or printed on the label, then adhered onto the tab 31.

The hanging file folder 30 may include hanging bar supports along the top edges of the front face 32 and rear face 31, and may protrude beyond the paper portion to form hooks 34A, 34B, 34C and 34D that engage the rails in the support rail structure (not shown). The file folder 30 includes side wall gussets 35A and 35B that may extend nearly all the way up to the hooks 34A-34D, or just below, which may help prevent the tops of the side wall gussets from being damaged by the support rails when the hanging file folder 30 is lifted out of the rail system.

It is possible to cant, (ie tip the top edges of the gussets inwardly to further prevent them from snagging. This could be done by many means including stiffening, with a plastic like reinforcement material and bending that portion such as when warm (hot melt).

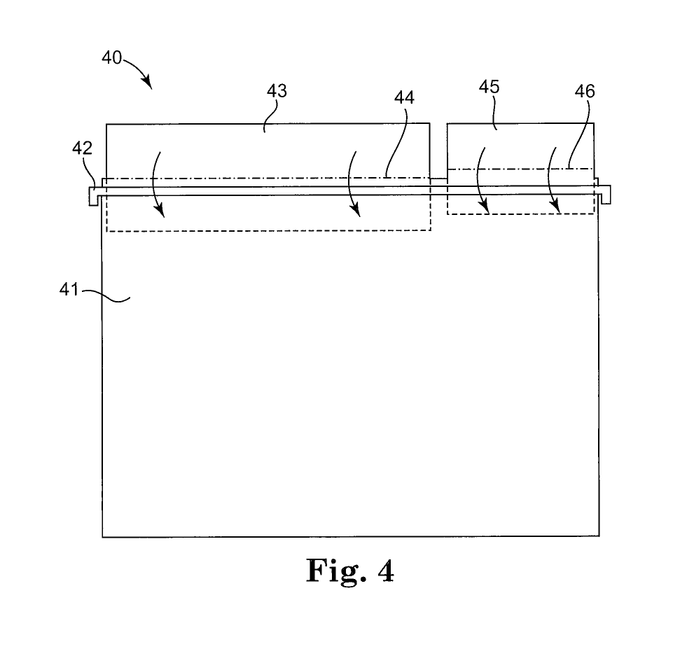

FIG. 4 is a plan drawing of a portion 40 of paper stock in an unassembled state, which shows the cutting and folding scheme for producing the integral tab shown in FIG. 3.

The paper for the front and rear faces of the hanging file folder is manufactured in long rolls, and then cut (or stamped), folded and glued into its final shape. Preferably, the process is automated, with the stamping wasting as little material as possible. The portion 40 shown in FIG. 4 will form the front or rear face 41 of a hanging file folder, once it is assembled.

The top edge of the stamped portion 40 may include a region 43 that will ultimately form the top edge of the face 41, and a region 45 that will ultimately form the integral tab on face 41. Preferably, the cut line region 43 may collinear with the cut line for region 45, so that a minimal amount of paper is wasted; here, only a small amount of material is wasted in the notch between regions 43 and 45. Region 43 has a fold line 44, and region 45 has a fold line 46. The fold lines 44 and 46 are not collinear, so that when folded, the integral tab is formed because the fold line is higher as shown in FIG. 4. The higher fold line creates a visible tab 31 in FIG. 3. Thus, in the preferred embodiment, fold line 46 will be more distant from the bar than fold line 44 thereby defining the tab height. Both regions 43 and 45 are folded over their respective fold lines, are folded over support bar 42, and glued to the face 41. Once glued, the folded regions will support the weight of the hanging file folder and its content, by keeping the face 41 attached to the support bar 42. Any or all of the corners on the face 41, including those in regions 43 and 45, may optionally be rounded. In addition, an optional sheet may be attached to the face 41 to hide the fold seams from regions 43 and 45.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A hanging pocket for use in a support frame having spaced apart support rails, said rails having upper and lower edges, comprising
a. a pocket having two generally spaced apart faces, having upper and lower edges, right and left edges;
b. a support bar affixed to said faces at said upper edges, said bar including hooks configured to ride on said rails;
c. a bottom panel joining said faces at said lower edges; and
d. a pair of corrugated side panels extending from said lower edges, joining said left and right edges of adjacent faces and terminating at least above the lower edges of said rails, when said pocket is supported by said hooks on said rails.

2. The hanging pocket according to claim 1 wherein said side panels terminate at a height at least between the upper and lower edge of said rails.

3. The hanging pocket according to claim 1 wherein said side panels terminate at a height at least equal to or above the upper edge of said rails.

4. A hanging pocket for use in a support frame having spaced apart support rails, said rails having upper and lower edges, comprising
a. a pocket having two generally spaced apart faces, having upper and lower edges, right and left edges;
b. a support bar affixed to said faces at said upper edges, said bar including hooks configured to ride on said rails;
c. a bottom panel joining said faces at said lower edges; and
d. a pair of an elastic side panel material extending from said lower edges, joining said left and right edges of adjacent faces and terminating at least above the lower edges of said rails, when said pocket is supported by said hooks on said rails.

5. The hanging pocket according to claim 4 wherein said side panels terminate at a height at least as high as the lower edge of said rails when said pocket is suspended by said rails.

6. A method of preventing snagging of side walls of a hanging pocket for use in a support frame having spaced apart support rails, said rails having upper and lower edges, a pocket having two generally spaced apart faces, having upper and lower edges, right and left edges; a support bar affixed to said faces at said upper edges, said bar including hooks configured to ride on said rails; bottom panel joining said faces at said lower edges; and a pair of corrugated side panels extending from said lower edges, joining said left and right edges of adjacent faces;
the method comprising, extending the side panels so they terminate at least above the lower edges of said rails, when said pocket is supported by said hooks on said rails.

7. A method of claim 6 wherein said method includes terminating said side panels at a height greater than said lower edges of said rails.

8. A hanging pocket according to claim 1 further including a foldable portion of one face extending beyond and above said support bar, said foldable portion being split into first and second portions, one of said portions being folded at a point spaced from an upper edge of the support bar thereby forming an integral tab in one portion of the face.
